(19) United States
(12) Patent Application Publication
(10) Pub. No.: US 2018/0242553 A1
(43) Pub. Date: Aug. 30, 2018

(54) Kit for storing and serving pet food

(71) Applicant: László NÉMETH, Pahoa, HI (US)

(72) Inventor: László NÉMETH, Pahoa, HI (US)

(21) Appl. No.: 15/441,459

(22) Filed: Feb. 24, 2017

(51) Int. Cl. A01K 5/01; B65D 25/04; B65D 43/02; B65D 65/46; A01K 7/00

(52) U.S. Cl. CPC A01K 5/0135; B65D 25/04; A01K 7/005; B65D 65/466; A01K 5/0121; B65D 43/0204

(57) ABSTRACT

A kit for storing and serving pet food is disclosed. The kit comprises a substantially flat tray having a circumferential flange on an upper face thereof and an anti-slip layer on at least a part of a lower face thereof, wherein the tray further comprises at least one securing member, each securing member upwardly protruding from said upper face of the tray; and a disposable container adapted for storing pet food, said container having a receptacle with a top opening and having along at least a part of its periphery, a double-walled configuration with a bottom opening between an inner wall and an outer wall thereof, said double-walled configuration defining a receiving space for a securing member of the tray; wherein the at least one securing member of the tray is configured to closely fit into a receiving space of the double-walled container.

### BACKGROUND OF THE INVENTION

A large variety of products for storing pet food are currently available on the market. These products have various shapes, sizes and forms. Metal cans are unsuitable for feeding pets directly from them due to their shapes and their sharp edges at the top of the opened cans. Furthermore, during a pet's feeding the container can be easily slit across a floor by the pet and the container can be even upset. Additionally, the sole use of a container, such as a bowl or a disposable can, usually results in a dirty floor around the container after feeding.

Document US 2003/0192480 discloses a feeding stand for a pet food package. The feeding stand includes a body comprising a bowl-shaped base defining a dish receptacle therein. The footing of the stand is separately fabricated from a resilient material, such as rubber, to prevent the stand from sliding across a floor when a pet is feeding. One of the drawbacks of this feeding stand is that it cannot prevent the surrounding floor from getting dirty while a pet is feeding. A further drawback of the above stand is that after feeding it is inconvenient to remove the empty food package from the receptacle of the stand.

It is an object of the present invention to eliminate at least the aforementioned drawbacks of the above feeding stand by providing an improved kit including pet food container and a supporting tray for the container.

### SUMMARY OF THE INVENTION

The above objects are achieved by providing a kit for storing and serving pet food, said kit comprising:
a substantially flat tray having a circumferential flange on an upper face thereof and an anti-slip layer on at least a part of a lower face thereof, wherein the tray further comprises at least one securing member, each securing member upwardly protruding from said upper face of the tray, and
a disposable container adapted for storing pet food, said container having a receptacle with a top opening and having along at least a part of its periphery, a double-walled configuration with a bottom opening between an inner wall and an outer wall thereof, said double-walled configuration defining a receiving space for a securing member of the tray, and
wherein the at least one securing member of the tray is configured to closely fit into a receiving space of the double-walled container.

### BRIEF DESCRIPTION OF THE DRAWINGS

The invention will now be described with reference to the drawings.

FIG. 1A is a schematic perspective view of a first embodiment of the kit according to the invention.

FIG. 1B is a sectional view of the container of the kit shown in FIG. 1A.

FIG. 1C is a top plan view of the tray of the kit shown in FIG. 1A.

FIG. 1D is a sectional view of the tray of the kit shown in FIG. 1A taken along the line A-A in FIG. 1C.

FIG. 2 is a top plan view of the tray of the kit according to a second embodiment of the present invention.

FIG. 3A is a schematic perspective view of a container used in a fourth embodiment of the kit according to the invention.

FIG. 3B is a sectional view of the container shown in FIG. 3A.

### DETAILED DESCRIPTION OF THE INVENTION

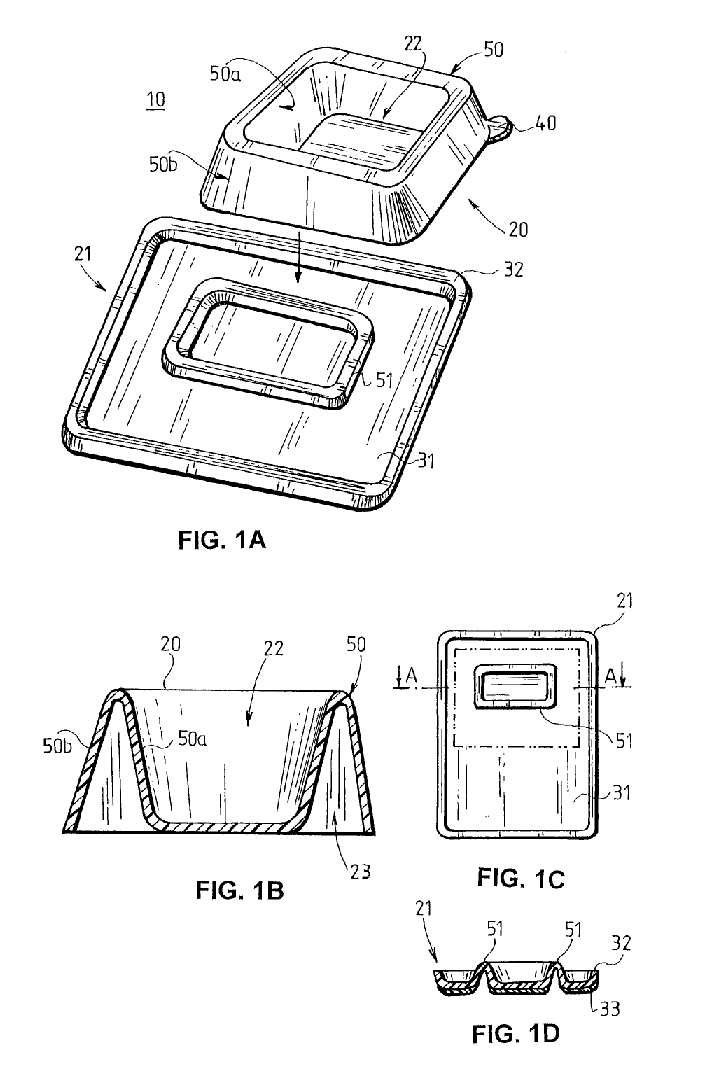

FIGS. 1A to 1D illustrate various views of a kit 10 including a disposable container 20 for pet food and a tray 21 supporting the container 20 according a first embodiment of the present invention. The container 20 has a receptacle 22 with a top opening and comprises along at least a part of its periphery, a double-walled configuration 50 with a bottom opening between an inner wall 50a and an outer wall 50b. The two walls 50a, 50b define a receiving space 23 for one or more securing members of a tray 21.

The tray 21 is formed to be substantially flat and it has a circumferential flange 32 on its upper face 31. The area of the tray 21 and the height of its flange 32 are dimensioned so that the tray 21 can collect that part of the pet food which accidentally falls down around the engaged container 20 during feeding. The tray 21 is preferably made of plastic, such as polyethylene, polyurethane or the like.

The tray 21 is provided with an anti-slip layer 33 on at least a part of its lower face opposite to said upper face 31. The anti-slip layer 33 may be formed integrally to the tray 21 as a roughened area on the bottom of the tray 21, or it may be formed as an additional coating layer directly applied to the lower face of the tray 21. In this latter case the coating layer may, for example, be made of rubber or other sticking or adhesive material (e.g. PVC). The anti-slip layer 33 substantially prevents the tray 21 from sliding across the floor when a pet is feeding.

The tray 21 comprises at least one securing member 51, each upwardly protruding from the upper face 31 of the tray 21. The one or more securing members 51 are configured to closely fit into a receiving space 23 of the double-walled container 20.

When the kit 10 is intended to be used for feeding a pet, the container 20 is to be pushed onto the tray 21 so that the securing member 51 of the tray 21 closely engages with the receiving space 23 of the container 20. For any kit according to the invention, the container 20 and the tray 21 are designed to allow their mutual engagement. It is noted that although the kit according to the invention comprises both of the container and the tray, they can be merchandized separately as well, in particular in those cases where the tray of the kit is a permanent part of the kit and the container is disposable and/or can be obtained as a part of a packaged pet food.

Although in FIGS. 1A to 1D, a substantially rectangular container and a substantially rectangular tray are shown, the container and the tray may have other shapes, like elliptical, circular or the like. The footing area of the container and the area of the flat tray are always dimensioned so that during use (i.e. when the container is engaged with the tray) the tray has a substantial free area around the container for protecting the floor from getting dirty while a pet is feeding. It is preferred that the tray is designed to have a food-collection zone (indicated by hatching in FIG. 1C) around an engaged container, the width of which is preferably about 8-10 cm or more.

As shown in FIG. 1A, the container 20 may be provided with a laterally projecting tab 40 at is bottom for facilitating the removal of the container 20 from the tray 21 when the container 20 and the tray 21 are engaged. The tab 40 therefore functions as a kind of lifting member. Other types of lifting member integrally formed on the outer wall of the container may also be conceivable, such as a handle, a recess, etc. (not shown in the drawings).

The volume of the receptacle of the container 20 may be fitted to the dimensions of a food package of regular size, and in this case the container may function even as a feeding stand like the one disclosed in US 2003/0192480.

The disposable container 20 is preferably made of plastic (e.g. polyethylene, polyurethane, etc.), but other suitable materials may also be used for it, like paper, cardboard, fiberboard, laminated board, metal, glass or any combination thereof. It is particularly preferred that the container 20 is disposable and made of a biodegradable material (e.g. polyethylene terephthalate, PET), which allows a very convenient, hygienic and environment-friendly use of the kit.

As shown in FIGS. 1A to 1D, the container 20 may have a double-wall configuration along its entire periphery and accordingly, the tray 21 may comprise a securing member 51 horizontally extending along a continuous loop corresponding to the shape of the double-walled periphery of the container 20.

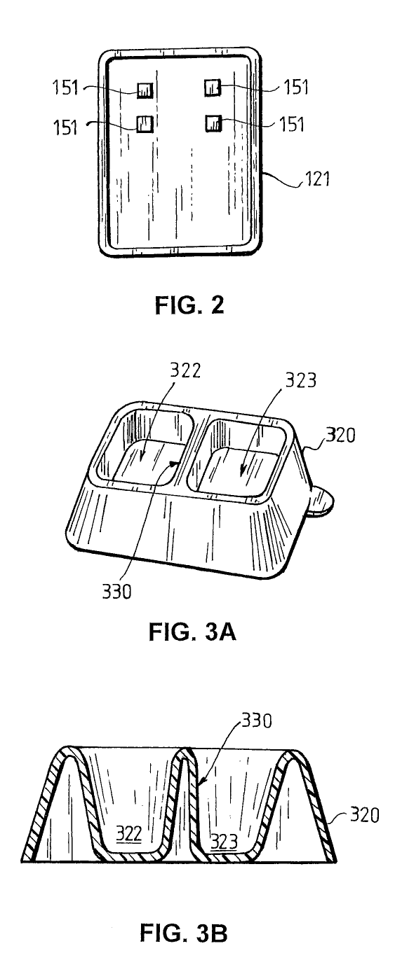

FIG. 2 illustrates a top plan view of a tray 121 used in a second exemplary embodiment of the kit according to the invention. In this embodiment multiple separate securing members 151 are arranged on the upper face of the tray 121 at positions matching to the receiving space of a suitable double-walled container (not shown). In this case the associated container may be designed to have a continuous double-walled configuration along its entire periphery as shown in FIGS. 1A and 1B, or it may comprise multiple separate double-walled sections, for example at its corners, wherein the securing members 151 of the tray 121 can be closely engaged with the corresponding (separate) receiving spaces of a respective container.

The container of the kit may comprise a removable cover, such as a flexible lid which can be snap-fitted on the top of the container, or a film adhered to the top of the container along its periphery. The flexible lid, which may be adapted for sealingly re-closing the container, may be made of plastic or other resilient material. The covering film may be a plastic film, preferably a translucent plastic film or a metal film or a multilayer laminated film. The covering film may also be adapted for sealingly re-closing the container. When the container comprises a re-closable cover, the container can be used to further store the remaining portion of packaged pet food product after feeding.

In a fourth embodiment of the kit according to the present invention, as shown in FIGS. 3A and 3B, the container 320 may comprise at least one partition 330 defining two compartments 322, 323 within the central receiving space of the container 320. The division of the space volume of the receptacle of the container into two or more compartments allows storing or serving different kinds of pet food (e.g. dry food and drinking water) at the same time.

The container of the kit is therefore suitable for storing and/or serving at least one of dry food, semi-dry, wet food and water.

One of the advantages of the kit according to the present invention is that the contaminated floor area may be substantially reduced in comparison with the conventional feeding stands, which considerably reduces the time needed to clean-up the floor after feeding a pet. The tray itself can be easily cleaned, e.g. washed up, once the container has been removed from it. This results in a much more hygienic use of the pet food containers than ever before. A further advantage of the kit of the invention is that when the tray and the container are engaged with each other, they form a stable assembly which is prevented from sliding across the floor. These features result in a much more hygienic use of the pet food container than before.

It should be understood that the present disclosure is illustrative only and that changes, variations, substitutions, modifications and equivalents will be readily apparent to one skilled in the art and that such may be made without departing from the spirit of the invention as defined by the following claims.

1. A kit for storing and serving pet food, said kit comprising:
a substantially flat tray having a circumferential flange on an upper face thereof and an anti-slip layer on at least a part of a lower face thereof, wherein the tray further comprises at least one securing member, each securing member upwardly protruding from said upper face of the tray, and
a disposable container adapted for storing pet food, said container having a receptacle with a top opening and having along at least a part of its periphery, a double-walled configuration with a bottom opening between an inner wall and an outer wall thereof, said double-walled configuration defining a receiving space for a securing member of the tray, and
wherein the at least one securing member of the tray is configured to closely fit into a receiving space of the double-walled container.

2. The kit according to claim 1, wherein the container has a double-walled configuration along its entire periphery, and the tray comprises a securing member horizontally extending along a continuous loop corresponding to shape of the double-walled periphery of the container.

3. The kit according to claim 1, wherein the said container has a double-walled configuration along its entire periphery, and the tray comprises multiple separate securing members at positions corresponding to the receiving space of the double-walled container.

4. The kit according to claim 1, wherein the said container comprises multiple separate double-walled sections, and the tray comprises multiple separate securing members at positions corresponding to the receiving spaces of the double-walled sections of the container.

5. The kit according to claim 1, wherein the container is provided with a lifting member for the removal of the container from the tray when the container and the tray are engaged.

6. The kit according to claim 1, wherein the container comprises a removable lid or film for sealingly closing said receptacle of the container.

7. The kit according to claim 1, wherein the container comprises at least one partition defining at least two compartments within said receptacle of the container.

8. The kit according to claim 1, wherein the container is made of a material selected from the group of paper, cardboard, fiberboard, laminated board, plastic, metal, glass and any combination thereof.

9. The kit according to claim 1, wherein the tray is made of plastic.

10. The kit according to claim 1, wherein the container is made of a biodegradable material.

11. A container for using as a part of the kit according to claim 1.

12. A tray for using as a part of the kit according to claim 1.
